(19) United States
(12) Patent Application Publication
(10) Pub. No.: US 2012/0274585 A1
(43) Pub. Date: Nov. 1, 2012

(54) SYSTEMS AND METHODS OF MULTI-TOUCH INTERACTION WITH VIRTUAL OBJECTS

(75) Inventors: Adam William Telfer, Waterloo (CA); Oliver ("Lake") Watkins, JR., Toronto (CA); Yousuf Chowdhary, Maple (CA); Jeffrey Brunet, Richmond Hill (CA); Ravinder ("Ray") Sharma, Toronto (CA)

(73) Assignee: XMG STUDIO, INC., Toronto (CA)

(21) Appl. No.: 13/421,380

(22) Filed: Mar. 15, 2012

Related U.S. Application Data
(60) Provisional application No. 61/465,159, filed on Mar. 16, 2011.

(51) Int. Cl. G06F 3/041

(52) U.S. Cl. 345/173

(57) ABSTRACT

A method is provided for enabling user interaction with virtual objects in a virtual world using a touchscreen device. A touch input within or across a region of the display is detected from the touchscreen device. After determining that the touch input exceeds a predetermined threshold, and further determining whether the touch input is of a single touch or multi-touch type based on a number of contacts detected in the touch input, a multi-touch type input is interpreted as a multi-touch attract or repel command with respect to a virtual object displayed on the display. The virtual object is then visibly moved or changed on the display in response.

### CROSS REFERENCE TO RELATED APPLICATIONS

This application claims priority from U.S. Provisional Application No. 61/465,159 filed on Mar. 16, 2011, which is incorporated by reference in its entirety herein.

### FIELD OF INVENTION

The present invention is related to multi-touch interaction with virtual objects in general, and in video game applications in particular.

### BACKGROUND

A virtual world is a computer simulated environment. A virtual world may resemble the real world, with real world rules such as physical rules of gravity, geography, topography, and locomotion. A virtual world may also incorporate rules for social and economic interactions between virtual characters. Player (users) may be represented as avatars, two or three-dimensional graphical representations. Virtual worlds may be used for massively multiple online role-playing games, for social or business networking, or for participation in imaginary social universes.

Virtual objects are non-physical objects in virtual worlds, online communities or online games. Virtual objects may include but are not limited to virtual characters, avatars, digital clothing for avatars, weapons, tokens, digital gifts, etc. or any other virtual objects used for gameplay.

Prior art methods for interacting with virtual objects include simple touchscreen mechanisms (gestures), but such gestures do not permit complex multi-touch interaction with (or manipulation of) virtual objects. The present invention overcomes these limitations of the prior art and provides a unique method and a system for interacting with virtual objects.

### SUMMARY OF THE INVENTION

This application describes systems and methods for interacting with virtual objects in virtual worlds whereby the player can interact with the virtual objects using multi-touch. For example in one embodiment of the invention a player can use several fingers simultaneously to interact with a virtual object in a virtual world.

Thus, a user (player) can interact with the virtual objects in a more natural, intuitive and interesting way. For example the virtual objects can be made to attract or repel as the multiple touch points are registered on the touchscreen. In other variations, the movement of the multi-touch points on the touchscreen may turn (rotate), compress or stretch the virtual object.

This provides for a richer gaming experience and increases player engagement while making the gameplay of the virtual world more involved. It is believed that the systems and methods described here can enable a player to have a unique and more enjoyable gaming experience.

According to a first aspect of the invention, a method is provided for enabling user interaction with virtual objects in a virtual world using a touchscreen device. A touch input within or across a region of the display is detected from the touchscreen device. After determining that the touch input exceeds a predetermined threshold, and further determining whether the touch input is of a single touch or multi-touch type based on a number of contacts detected in the touch input, a multi-touch type input is interpreted as a multi-touch attract or repel command with respect to a virtual object displayed on the display. The virtual object is then visibly moved or changed on the display in response.

For example, the multi-touch attract or repel command may be used to visibly move the virtual object away from (or toward) the region of the touch input; or to visibly rotate the virtual object; or to visibly compress, stretch or deform the virtual object.

There may be a plurality of virtual objects, in which case the multi-touch attract or repel command may be used to corral or bring together the virtual objects; or to disperse the virtual objects.

A second touch input may be detected as received from the touchscreen device (within or across a non-overlapping second region of the display). (This is processed more or less like the first touch input.) After determining that the second touch input exceeds a predetermined threshold, and further determining whether the second touch input is of single touch or multi-touch type based on a number of contacts detected in the second touch input, the second multi-touch input can be interpreted as a second multi-touch attract or repel command. (An example of a second touch input is a head-to-head game involving two (or more) players, each applying multiple fingers on the touchscreen. Another example of a second touch input is a single-player game where the player uses the fingers/thumbs of both hands (where the left hand is one “touch input” and the right hand is another “touch input”).

For example, the first and second multi-touch attract or repel commands can be used to visibly, move the virtual object between the first and second regions; or to visibly move the virtual object away from (or toward) the first and second regions; or to visibly compress, stretch or deform the virtual object.

There may be a plurality of virtual objects, in which case the first and second multi-touch attract or repel commands may be used to corral or bring together the virtual objects; or to disperse the virtual objects.

In one example, the virtual world may comprise a virtual game, and the virtual object may be a game object. The multi-touch attract or repel command may be used to score points or advance the game.

In another example, the virtual world may be a graphical editor (e.g. in which the multi-touch attract or repel command may be used to modify the appearance of, or otherwise manipulate, graphical object(s) being edited).

According to a second aspect of the invention, a touchscreen device is provided (having a display and a processor). The touchscreen device is programmed for detecting a touch input within or across a region of the display on the device, determining that the touch input exceeds a predetermined threshold, and determining whether the touch input is of a single touch or multi-touch type based on a number of contacts detected in the touch input. If the touch input is of multi-touch type, the device is programmed for interpreting the touch input as a multi-touch attract or repel command with respect to a virtual object displayed on the display, such that the virtual object can be visibly moved or changed on the display in response to the multi-touch attract or repel command.

The touchscreen device may have a resistive touchscreen, or a capacitive sensing touchscreen (or some other touchscreen technology).

In one embodiment, the touchscreen device is a game device. The touchscreen device may also (or in the alternative) be a mobile device.

### BRIEF DESCRIPTION OF THE FIGURES

FIG. 1 is a flow diagram of the method according to a preferred embodiment;

FIG. 2 is a sample screen diagram of a touchscreen device showing virtual objects without touch influence (baseline);

FIG. 3 is a sample screen diagram of a touchscreen device showing virtual objects under a repel-type interaction;

FIG. 4 is a sample screen diagram of a touchscreen device showing virtual objects under an attract-type interaction;

FIG. 5 is a sample screen diagram of a touchscreen device showing virtual objects under a crush/compress-type interaction;

FIG. 6 is a sample screen diagram of a touchscreen device showing virtual objects under a stretch-type interaction;

FIG. 7 is a sample screen diagram of a touchscreen device showing virtual objects under a rotation-type interaction; and

FIG. 8 is a chart of membership functions showing sample influences on a virtual character.

### DETAILED DESCRIPTION

Methods and arrangements of multi-touch interaction with virtual objects in virtual worlds and gaming applications are disclosed in this application.

Before embodiments of the invention are explained in detail, it is to be understood that the invention is not limited in its application to the details of the examples set forth in the following descriptions or illustrated drawings. The invention is capable of other embodiments and of being practiced or carried out for a variety of applications and in various ways. Also, it is to be understood that the phraseology and terminology used herein is for the purpose of description and should not be regarded as limiting.

Further, it should be noted that the invention is not limited to any particular software language described or implied in the figures and that a variety of alternative software languages may be used for implementation of the invention.

It should also be understood that many components and items are illustrated and described as if they were hardware elements, as is common practice within the art. However, persons skilled in the art, and based on a reading of this detailed description, would understand that, in at least one embodiment, the components comprised in the method and tool are actually implemented in software.

As will be appreciated by persons skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “virtual world” as used herein need not be a “game” in the traditional sense of a competition in which a winner and/or loser is determined. The term “game” incorporates the idea of a virtual world, in which a person or entity who enters the virtual world in order to conduct business, tour the virtual world, or simply interact with others or the virtual environment, with or without competing against another person or entity. Users engaged with a virtual world in this sense are still considered to be “playing a game” or engaging in the gameplay of the game.

Virtual worlds can exist on game consoles for example Microsoft Xbox, and Sony Playstation, Nintendo Wii, etc., or on online servers, or on mobile devices (e.g. an iPhone or an iPad), Smartphones, portable game consoles like the Nintendo 3DS, or on a PC (personal computer) running MS Windows, or MacOS, Linux or another operating system. This list is not exhaustive but is exemplary of devices or computing environments where virtual worlds can exist. Many other variations are available and would be within the knowledge of persons skilled in the art.

A virtual world that incorporates the invention, either in its entirety or some components of it, may be a single player game or a multiplayer game or a MMORPG (Massively Multiplayer Online Role Playing Game) and may exist on any type of a gaming device which provides a touch interface, and may include but not limited to an iPhone, iPad, Smartphones, Android phones, personal computers e.g. laptops, tablet computers, touchscreen computers, gaming consoles and online server based games being played via a touchscreen capable interface etc. The computer program comprises: a computer usable medium having computer usable program code, the computer usable program code comprises: computer usable program code for presenting graphically to the player the different options available to engage in gameplay via the touchscreen interface.

The system may include a computer or a game console that enables a user to engage with a virtual world, including a memory for storing a control program and data, and a processor (CPU) for executing the control program and for managing the data, which includes user data resident in the memory including a set of gameplay statistics. The computer, or a game console, may be coupled to a video display such as a television, monitor, or other type of visual display while other devices may have it incorporated in them (iPad). A game or other simulations may be stored on a storage media such as a DVD, a CD, flash memory, USB memory or other type of memory media. The storage media can be inserted to the console where it is read. The console can then read program instructions stored on the storage media and present a game interface to the user.

The term “player” (used interchangeably herein with “user”) is intended to describe any entity that accesses the virtual world, regardless of whether or not the player intends to or is capable of competing against other players. Typically, a player will register an account with the game console within a peer-to-peer game and may choose from a list or create virtual characters that can interact with other virtual characters of the virtual world.

The term “engage in gameplay” generally implies playing a game whether it is for the purpose of competing, beating, or engaging with other players. It also means to enter a virtual world in order to conduct business, tour a virtual world, or simply interact with others or a virtual environment, with or without competing against another entity. Further, a virtual world may also include editing facilities where virtual objects are developed, edited or manipulated.

Typically, a user or a player manipulates a game controller to generate commands to control and interact with the virtual world. The game controller may include conventional controls, for example, control input devices such as joysticks, buttons and the like. Using the controller a user can interact with the game, such as by using buttons, joysticks, and movements of the controller and the like. This interaction or command may be detected and captured in the game console. The user's inputs can be saved, along with the game data to record the game play.

Another method to interact with a virtual world is using a touchscreen. There are several methods for touchscreen implementations e.g. a capacitive screen or a resistive screen. Touchscreens as a human interface device (HID) technology, for example to replace the computer mouse, is becoming increasingly popular and provide for a unique way of interacting with the computer. There are several different technological ways of implementing this, some of the more popular methods widely used in the industry are described below.

Resistive touchscreens are touch-sensitive displays composed of two flexible sheets coated with a resistive material and separated by an air gap or microdots. When contact is made to the surface of the touchscreen, the two sheets are pressed together. There are horizontal and vertical lines on these two screen that when pushed together, register the precise location of the touch. Because the touchscreen senses input from contact with nearly any object (finger, stylus/pen, palm) resistive touchscreens are a type of “passive” technology.

Capacitive sensing is a technology based on capacitive coupling that is used in many different types of sensors, including those for detecting and measuring: proximity, position or displacement, humidity, fluid level, and acceleration. Capacitive sensors are used in devices such as laptop trackpads, MP3 players, computer monitors, cell phones and others. Capacitive sensors are used widely for their versatility, reliability and robustness, providing a unique human-device interface and cost reduction over mechanical switches. Capacitive touch sensors now feature prominently in a large number of mobile devices e.g. Smartphones, MP3 players etc.

In surface capacitance, only one side of the insulator is coated with a conductive layer. A small voltage is applied to the conductive layer, resulting in a uniform electrostatic field. When a conductor, such as a human finger, touches the uncoated surface, a capacitor is dynamically formed. The sensor's controller can determine the location of the touch indirectly from the change in the capacitance as measured from the four corners of the panel. This kind of touchscreen has no moving parts, therefore it is moderately more durable but has limited resolution. It is also prone to false signals from parasitic capacitive coupling, and needs calibration during manufacturing. It is therefore most often used in simple applications such as industrial controls and kiosks.

Although a few exemplary touchscreen technologies are described above, the methods and systems described in this application are intended to work with any kind of a touchscreen technology.

Current methods define simple ways of using the touchscreen for this interaction through gestures. A gesture refers to a motion used to interact with multipoint touchscreen interfaces. Touchscreen devices may employ gestures to perform various actions. Some examples are given below:

On iOS devices (iPhone, iPad etc.), a one-finger “swipe” may be used to unlock the device. On Blackberry OS6 devices, one-finger swipe may be used to scroll through different menus on the homescreen and other screens within the OS.

A “pinch” refers to pinching together the thumb and finger, and may be used to zoom out on an image.

A “reverse pinch” (sometimes also called “unpinch”) refers to spreading two fingers (or thumb and finger) apart, and may be used to enlarge a picture or zoom in on an image.

A “virtual object” may comprise any one of the following in a video game, an online game, or other virtual game environment: a virtual character, a virtual good, a weapon, a vehicle, virtual currency, experience points and permissions, etc. A virtual object may further be any item that exists only in a virtual world (game).

“Virtual goods” may include virtual money, experience points, weapons, vehicles, credentials, permissions and virtual gold. A player's online persona may obtain these virtual goods via gameplay, purchase or through other means of developing or acquiring virtual goods. For example, as a player of a first person shooter completes various levels of the game, he obtains additional weapons, armor, outfits, experience points and permissions. Additional weapons and armor (which may be beneficial in facilitating the completion of levels and allowing the player to perform in new and different ways) may be acquired (e.g. purchased). Additional permissions may unlock additional levels of the game or provide access to an otherwise hidden forum or stage. Virtual goods are sought by players to enrich their game experience, or to advance the game.

A “virtual character” may include a persona created by a player or chosen from a list in the virtual world. Typically virtual characters are modeled after humans whether living or fantasy (e.g. characters from mythology).

A virtual character is represented by one or more gameplay statistics, which encapsulate some meaning to connect the virtual (and digital) reality of the game to the real world. Many of these statistics are not apparent to the user as such, but are instead encoded within the framework of the game or composed together to form a script. In role-playing games (RPGs) and similar games, these statistics may be explicitly exposed to the user through a special interface, often with added meaning which provides context for the user's actions.

In virtual worlds (video/computer games), a “non-player character” (NPC) is a virtual character that is controlled by the program and not a player. NPC may also refer to other entities not under the direct control of players. NPC behavior in a virtual world may be scripted and automatic.

A “player character” or “playable character” (PC) is a virtual character in a virtual world that is controlled or controllable by a player. A player character is a persona of the player who controls it. In some cases, a virtual world has only one player character. In other cases, there may be a small number of player characters from which a player may pick a certain virtual character that may suit his or her style of gameplay. In yet other scenarios, there may be a large number of customizable player characters available from which a player may choose a virtual character of their liking. An “avatar” may include the physical embodiment of a virtual character in the virtual world.

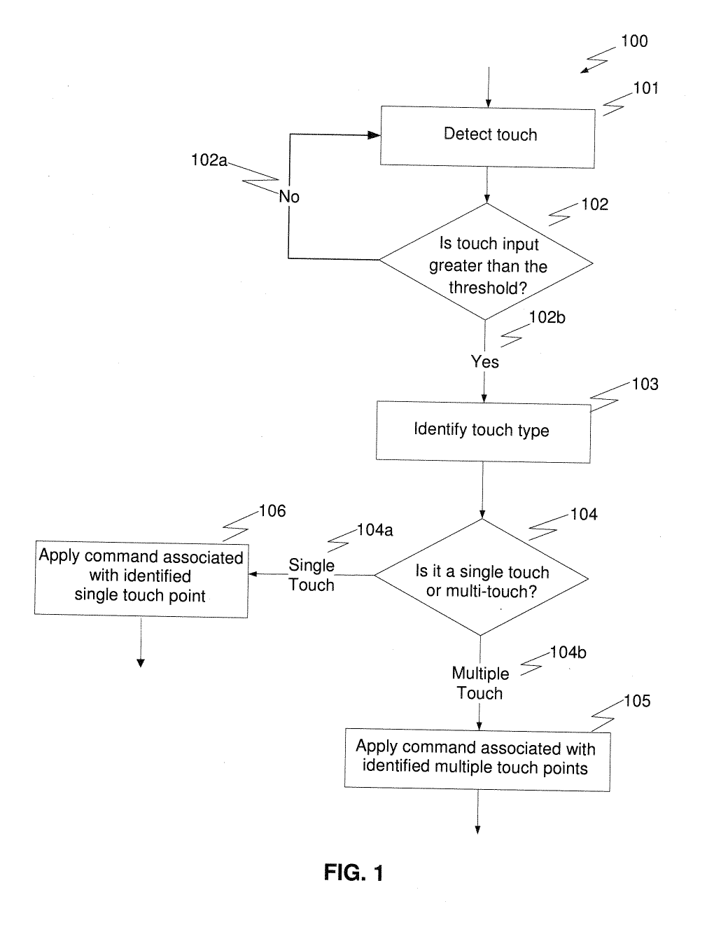

Having defined a number of the terms used in virtual worlds and games, and having set the stage for the technology, we now turn to a description of the present method. A flow diagram illustrating a preferred embodiment of the method is shown in FIG. 1.

Within a virtual world where the player can interact with the virtual objects using a touchscreen, a user touch input is detected 101. When the touch input is received, the system determines whether the touch input is greater than the threshold 102. (For example, the threshold may be used to rule out accidental or unintentional touches.) If No, 102a then continue the loop to detect the touch. If Yes, 102b then identify the touch type 103. The system checks if a single touch point is registered on the touchscreen or multi-touch points have been registered on the touchscreen 104.

If a single touch point has been registered on the touchscreen 104a, then the system applies the command(s) associated with the identified single touch point in context of the gameplay 106.

If multiple touch points have been registered on the touchscreen 104b, then the system applies the command(s) associated with identified multi-touch points in context of the gameplay 105.

Several exemplary embodiments/implementations of the invention of interacting with virtual objects using multi-touch are given below. There may be other methods obvious to persons skilled in the art, and the intent is to cover all such scenarios. The application is not limited to the cited examples, but the intent is to cover all such areas that may be used in a virtual world.

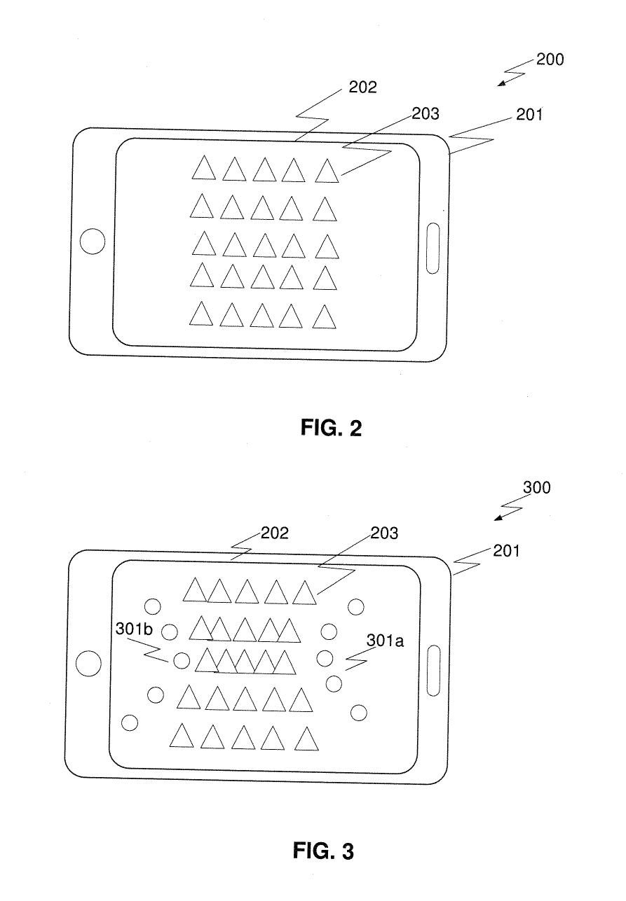

FIG. 2 shows a touchscreen device 201. On its touchscreen 202 is displayed a set of virtual objects 203.

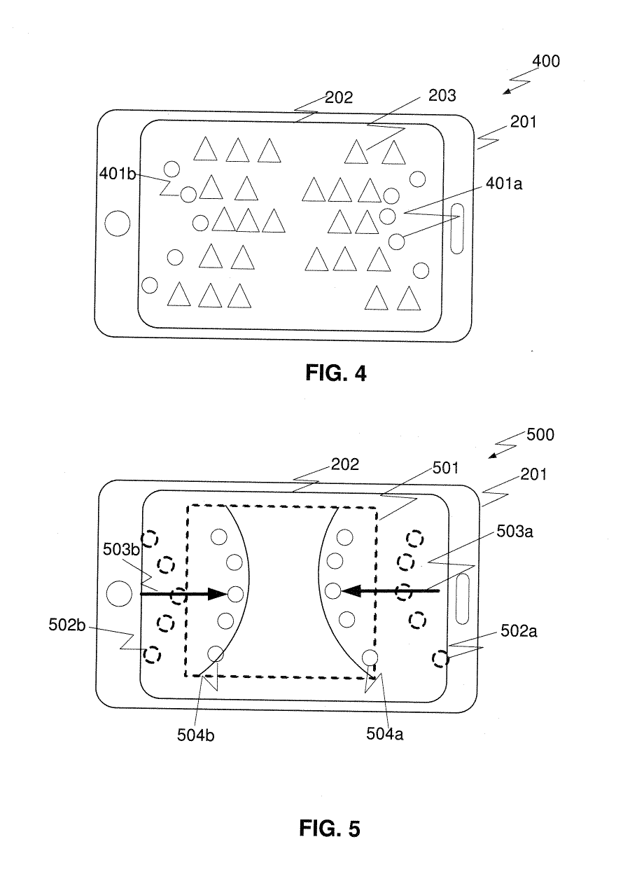

The positions of the virtual objects 203 are without any touch influence. For FIGS. 3 and 4 that follow, FIG. 2 is used as a baseline to show the results of the multi-touch interaction. Therefore the virtual objects in FIG. 2 can be viewed as the starting point for the virtual objects in FIGS. 3 and 4.

FIG. 3 shows a sample repel/repulsion type interaction. FIG. 3 shows a touchscreen device 201 and on its screen 202 is displayed a set of virtual objects 203 that have moved away from the region defined by the multiple points where the player's fingers 301a and 301b have touched the screen 202; i.e. the points where the touch points were registered on the touchscreen. Thus the virtual objects 203 have bunched up in the center as if they are being repelled by the touch points. The virtual objects may return to their previous positions as displayed in FIG. 2, when the touch has been removed, or may remain in the new position until further influenced, as the gameplay of the virtual world requires.

FIG. 4 shows a sample attraction type interaction. FIG. 4 below shows a touchscreen device 201 and on its screen 202 is displayed a set of virtual objects 203 that have moved away from the points where player's fingers 401a and 401b have touched the screen 202, i.e. the points where the touch points were registered on the touchscreen. Thus the virtual objects 203 have clustered towards the points where the multiple touches have been registered on the screen 202 as if the virtual objects are being attracted to the multiple touch points. Once the touch has been removed, the virtual objects 203 may return to their previous positions as displayed in FIG. 2, or may remain in the new position until further influenced, as the gameplay of the virtual world requires.

FIG. 5 shows an embodiment of the invention 500, where the multi-touch is a compression/crushing influence. The touchscreen device 201 has a touchscreen 202 showing a virtual object 501 whose original shape is shown with the dotted lines. When multi-touch inputs 502a and 502b (dotted circles) are received and then dragged along the touchscreen towards the centre (inside) of the screen as depicted by arrows 503a and 503b, with final positions of the multi-touch points being 504a and 504b (solid circles), the result in this example is a crushing effect on the virtual object 501 whose final shape is shown with solid lines. It is as if the virtual object has been crushed or compressed inwards by the pushing force of the multiple touch points registered on the touchscreen.

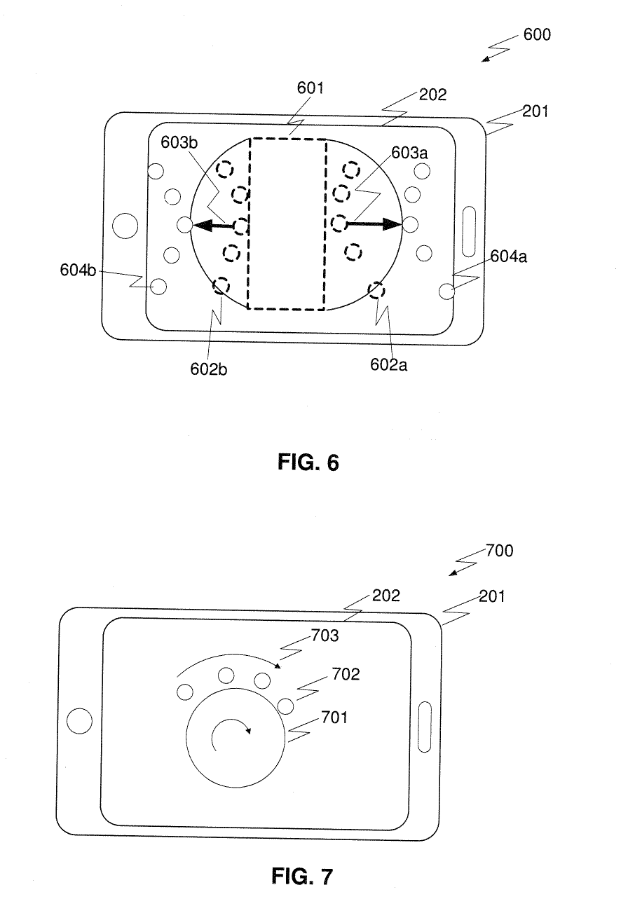

FIG. 6 shows an embodiment of the invention 600, where the multi-touch is a stretching influence. The touchscreen device 201 has a touchscreen 202 showing a virtual object 601 whose original shape is shown with the dotted lines. Multi-touch points 602a and 602b (dotted circles) are placed on the touchscreen and then moved towards the outside edges of the device (as shown by the arrows 603a and 603b), with the final positions of the multi-touch points being 604a and 604b (solid circles). The result in this example is a stretching effect on the virtual object 601 whose final shape is shown with solid lines. It is as if the virtual object has been stretched out (or elongated) by the dragging force of the multiple touch points registered on the touchscreen.

FIG. 7 shows an embodiment of the invention 700, where the multi-touch produces a rotation influence on the virtual object. The touchscreen device 201 has a touchscreen 202 showing a virtual object 701. When multi-touch points 702 are placed on the touchscreen and then moved in a circular curve as shown by the arrow 703, this produces a rotational influence on the virtual object 701. Thus a virtual object may be rotated by placing multiple fingers around it and then moving the fingers in a circular motion.

In one embodiment a virtual game where combination locks can be opened and closed by rotating the lock dials in clockwise or anti-clockwise motions of multiple fingers placed around the lock dials.

The game context will prescribe what effect the multi-touch will have under a given set of circumstances. Whether a virtual object is to be repelled, attracted, compressed or stretched depends on the context of the game. For example, in a given game each level may have its own context. For example, red virtual objects may be repelled, blue virtual objects attracted, green virtual objects compressed and yellow virtual objects stretched (the player is given clues using colors to distinguish between virtual objects).

These simple examples illustrate various scenarios where multi-touch influences are summed to create an effect on a virtual object. Each touch point can be imagined like a magnet. The magnet has a sphere/area of influence (like a force field). Combining these together, the combined effect can be like a wall of these force fields acting as one.

However, multi-touch influence can also combine with, cancel or otherwise interact with other influences. For example, a game may have gravity and wind in the game, and falling virtual objects may be attracted using multiple fingers at the top to stop them or slow them from hitting the floor, while fingers used at the bottom of the virtual objects are used to repel them and thus stop them or slow them from hitting the floor.

The velocity with which the fingers are moved across the touchscreen (either in a straight line or in a circular motion) may also have an effect on the virtual object. For example, in a virtual game where virtual tops can be launched by player(s) the faster the fingers are moved across the touchscreen in a circular motion, the faster the virtual object (top) rotates.

Virtual objects in a virtual world interact with the player, the virtual environment, and each other. This interaction is generally governed by a physics engine which enables realism in modeling physical rules of the real world (or arbitrary fantasy worlds). A physics engine is a computer program that, using variables such as mass, force, velocity, friction and wind resistance, may simulate and predict effects under different conditions that would approximate what happens in either the real world or a fantasy world. A physics engine can be used by other software programs (for example games or animation software) to enhance the way virtual objects imitate the real world to produce games and animations that are highly realistic or to create dream-world effects.

The force F applied on a virtual object at a location (x, y) is determined by the following:

$$F ( x , y ) = {\sum }_{i = 0}^{n} \frac{{p}_{i} \times {f}_{i}}{\sqrt{{( x - {x}_{i} )}^{2} + {( y - {y}_{i} )}^{2}}}$$

### Where:

n=number of influences
fi=force applied by influence at index i on object
pi=priority of influence at index i for object
(xi, yi)=position of influence at index i

The force or “priority” of a particular influence may be determined by an equation (such as a membership function for a fuzzy set), it may be a static property of the influence itself, or it may be a static property of the object being influenced. An example of each is described below:

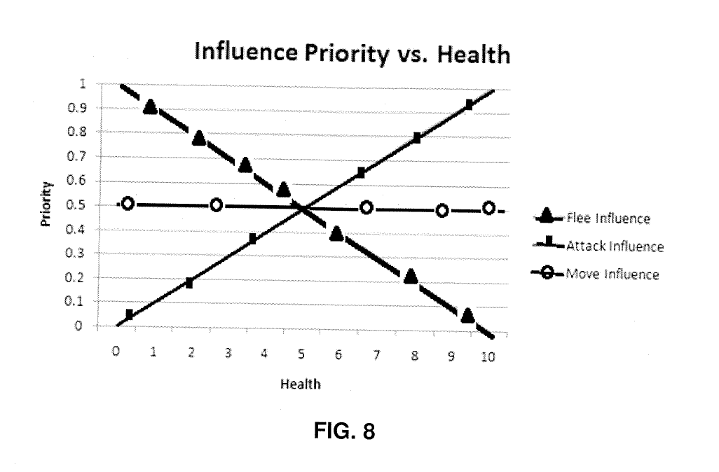

Suppose that there are three influences applying forces to a virtual character. Each influence has a position, magnitude, direction, and priority. As above, the sum of these influential forces applied over a distance, times a specific priority, determines the final force to be applied to the game character. FIG. 8 shows a chart which describes the membership functions for each influence (flee, attack, move) based on the health of the virtual character.

As the chart shown in FIG. 8 suggests, if a virtual character's health is low, then the flee influence's priority is higher than the attack influence's priority. In contrast, when the virtual character's health is high the attack influence has higher priority. The move influence is indifferent to the virtual character's health, as the move influence is determined instead by the placement and pressure of the player's fingers, i.e. the multiple touch points registered on the touchscreen.

Health is a game mechanic used in virtual worlds to give a value to virtual characters, enemies, NPCs (non player characters), and related virtual objects. Health is often abbreviated by HP which may stand for health points or hit points; it is also synonymous with damage points or heart points. In virtual worlds, health is a finite value that can either be numerical, semi-numerical as in hit/health points, or arbitrary as in a life bar, and is used to determine how much damage (usually in terms of physical injury) a virtual character can withstand when said virtual character is attacked, or sustains a fall. The total damage dealt (which is also represented by a point value) is subtracted from the virtual character's current HP. Once the virtual character's HP reaches 0 (zero), the virtual character is usually unable to continue to fight or carry forward the virtual world's mission.

A typical life bar is a horizontal rectangle which may begin full of colour. As the virtual character is attacked and sustains damage or mistakes are made, health is reduced and the coloured area gradually reduces or changes colour, typically from green to red. At some point the life bar changes colour completely or loses colour, at this point the virtual character is usually considered dead.

At the start of a typical game, the virtual character may have 10 health and be surrounded by numerous enemies. Each enemy applies an attack influence (a force toward the enemy) and a flee influence (a force away from the enemy) to the virtual character. Given these circumstances, the attack influence would carry the strongest priority, and so we would expect the virtual character to move toward the closest enemy (since influence is inversely proportional to distance).

This default behavior can be overridden by the player simply by touching the screen, introducing another influence. By moving their finger closer to the virtual character or applying more pressure, this influence will be greater, while the direction of the influence will be determined by the position of the touch points registered on the touchscreen, relative to the virtual character and whether the touch applies an attractive or repulsive effect in this context.

The above examples are not intended to be limiting, but are illustrative and in fact the present system may use any other algorithm so suited for prioritizing or calculating net effect of the various influences.

One embodiment of the invention may preferably also provide a framework or an API (Application Programming Interface) for virtual world creation that allows a developer to incorporate the functionality of interacting with virtual objects using multi-touch. Using such a framework or API allows for a more uniform virtual world generation, and eventually allows for more complex and extensive ability to interact with virtual objects.

It should be understood that although the term game has been used as an example in this application but in essence the term may also imply any other piece of software code where the embodiments of the invention are incorporated. The software application can be implemented in a standalone configuration or in combination with other software programs and is not limited to any particular operating system or programming paradigm described here. For the sake of simplicity, we singled out game applications for our examples. Similarly we described users of these applications as players. There is no intent to limit the disclosure to game applications or player applications. The terms players and users are considered synonymous and imply the same meaning. Likewise, virtual worlds, games and applications imply the same meaning. Thus, this application intends to cover all applications and user interactions described above and others obvious to persons skilled in the art.

Although interacting with virtual objects is has been exemplified above with reference to gaming, it should be noted that virtual objects are also associated with many industries and applications. For example, virtual worlds/objects can be used in movies, cartoons, computer simulations, and video simulations, among others. All of these industries and applications would benefit from the disclosed invention.

The examples noted here are for illustrative purposes only and may be extended to other implementation embodiments. While several embodiments are described, there is no intent to limit the disclosure to the embodiment(s) disclosed herein. On the contrary, the intent is to cover all alternatives, modifications, and equivalents obvious to those familiar with the art.

What is claimed is:

1. A method of enabling user interaction with virtual objects in a virtual world using a touchscreen device having a display, comprising:
detecting a touch input received from the touchscreen device, the touch input being detected within or across a region of the display on the touchscreen device;
determining that the touch input exceeds a predetermined threshold;
determining whether the touch input is of a single touch or multi-touch type based on a number of contacts detected in the touch input; and
if the touch input is of multi-touch type, interpreting the touch input as a multi-touch attract or repel command with respect to a virtual object displayed on the display, and visibly moving or changing the virtual object on the display in response to the multi-touch attract or repel command.

2. The method of claim 1, wherein the multi-touch attract or repel command is used to visibly move the virtual object away from the region of the touch input.

3. The method of claim 1, wherein the multi-touch attract or repel command is used to visibly rotate the virtual object.

4. The method of claim 1, wherein the multi-touch attract or repel command is used to visibly compress, stretch or deform the virtual object.

5. The method of claim 1, wherein there is a plurality of virtual objects, and the multi-touch attract or repel command is used to corral or bring together the virtual objects.

6. The method of claim 1, wherein there is a plurality of virtual objects, and the multi-touch attract or repel command is used to disperse the virtual objects.

7. The method of claim 1, further comprising:
detecting a second touch input received from the touchscreen device, the second touch input being detected within or across a non-overlapping second region of the display;
determining that the second touch input exceeds a predetermined threshold;
determining whether the second touch input is of single touch or multi-touch type based on a number of contacts detected in the second touch input; and
if the second touch input is of multi-touch type, interpreting the second touch input as a second multi-touch attract or repel command.

8. The method of claim 7, wherein the first and second multi-touch attract or repel commands are used to visibly move the virtual object between the first and second regions.

9. The method of claim 7, wherein the first and second multi-touch attract or repel commands are used to visibly move the virtual object away from the first and second regions.

10. The method of claim 7, wherein the first and second multi-touch attract or repel commands are used to visibly compress, stretch or deform the virtual object.

11. The method of claim 7, wherein there is a plurality of virtual objects, and the first and second multi-touch attract or repel commands are used to corral or bring together the virtual objects.

12. The method of claim 7, wherein there is a plurality of virtual objects, and the first and second multi-touch attract or repel commands are used to disperse the virtual objects.

13. The method of claim 1, wherein the virtual world comprises a virtual game.

14. The method of claim 13, wherein the virtual object is a game object.

15. The method of claim 13, wherein the multi-touch attract or repel command is used to score points or advance the game.

16. The method of claim 1, wherein the virtual world comprises a graphical editor.

17. A touchscreen device having a display and a processor, the touchscreen device operable to:
detect a touch input, the touch input being detected within or across a region of the display on the device;
determine that the touch input exceeds a predetermined threshold;
determine whether the touch input is of a single touch or multi-touch type based on a number of contacts detected in the touch input; and
if the touch input is of multi-touch type, interpret the touch input as a multi-touch attract or repel command with respect to a virtual object displayed on the display, and visibly move or change the virtual object on the display in response to the multi-touch attract or repel command.

18. The touchscreen device of claim 17, wherein the touchscreen device has a resistive touchscreen.

19. The touchscreen device of claim 17, wherein the touchscreen device has a capacitive sensing touchscreen.

20. The touchscreen device of claim 17, wherein the touchscreen device is a game device.

21. The touchscreen device of claim 17, wherein the touchscreen device is a mobile device.
